(19) United States
(12) Patent Application Publication
(10) Pub. No.: US 2023/0325552 A1
(43) Pub. Date: Oct. 12, 2023

(54) METHODS OF DETERMINING SUITABILITY OF A WIRE BONDING TOOL FOR A WIRE BONDING APPLICATION, AND RELATED METHODS

(71) Applicant: Kulicke and Soffa Industries, Inc., For Washington, PA (US)

(72) Inventors: Basil Milton, Fort Washington, PA (US); Wei Qin, Fort Washington, PA (US)

(21) Appl. No.: 18/116,798

(22) Filed: Mar. 2, 2023

Related U.S. Application Data
(60) Provisional application No. 63/327,855, filed on Apr. 6, 2022.

(51) Int. Cl. G06F 30/18

(52) U.S. Cl. CPC G06F 30/18; G06F 2113/16

(57) ABSTRACT

A method of determining suitability of a wire bonding tool for a wire bonding application is provided. The method includes the steps of: (a) providing specifications for a wire bonding tool; and (b) determining if the wire bonding tool is acceptable for a wire bonding application using (i) a software tool and (ii) the specifications provided in step (a).

### CROSS REFERENCE TO RELATED APPLICATION

This application claims the benefit of U.S. Provisional Application No. 63/327,855, filed on Apr. 6, 2022, the content of which is incorporated herein by reference.

### FIELD

The invention relates to wire bonding operations, and in particular, to methods of determining if a wire bonding tool is suitable for a wire bonding application.

### BACKGROUND

In the processing and packaging of semiconductor devices, wire bonding continues to be the primary method of providing electrical interconnection between two locations within a package (e.g., between a die pad of a semiconductor die and a lead of a leadframe). More specifically, using a wire bonder (also known as a wire bonding machine), wire loops are formed between respective locations to be electrically interconnected. The primary methods of forming wire loops are ball bonding and wedge bonding. In forming the bonds between (a) the ends of the wire loop and (b) the bond site (e.g., a die pad, a lead, etc.) varying types of bonding energy may be used, including, for example, ultrasonic energy, thermosonic energy, thermocompressive energy, amongst others. Wire bonding machines (e.g., stud bumping machines) are also used to form conductive bumps from portions of wire.

Wire bonding tools (e.g., capillary tools, wedge bonding tools, etc.) are used in wire bonding processes. Certain wire bonding tools are not suitable for all wire bonding applications. Thus, it would be desirable to provide improved methods for determining if a wire bonding tool is suitable for a wire bonding application.

### SUMMARY

According to an exemplary embodiment of the invention, a method of determining suitability of a wire bonding tool for a wire bonding application is provided. The method includes the steps of: (a) providing specifications for a wire bonding tool; and (b) determining if the wire bonding tool is acceptable for a wire bonding application using (i) a software tool and (ii) the specifications provided in step (a).

The methods of the present invention may also be embodied as an apparatus (e.g., as part of the intelligence of a wire bonding machine), or as computer program instructions on a computer readable carrier (e.g., a computer readable carrier including a wire bonding program used in connection with a wire bonding machine).

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIGS. 1A-1B are cross-sectional side views illustrating a conventional wire bonding tool;

FIGS. 2A-2B are cross-sectional side views illustrating another conventional wire bonding tool;

FIGS. 3A-3B are side and top block diagram illustrations of a semiconductor package, useful for explaining various exemplary embodiments of the invention;

FIGS. 4A-4D are various block diagram illustrations of simulations of wire bonding tools used in connection with a wire bonding application in accordance with various exemplary embodiments of the invention; and

FIG. 5 is a flow diagram illustrating a method of determining suitability of a wire bonding tool for a wire bonding application in accordance with an exemplary embodiment of the invention.

### DETAILED DESCRIPTION

In wire bonding (e.g., ball bonding), the overall shape and dimensions of a wire bonding tool (e.g., a capillary tool) is an important factor that influences wire pitch capability as well as the overall feasibility of a semiconductor package design. Exemplary aspects of the invention involve simulating the wire bonding tool specifications (e.g., the shape, geometry, dimensions, etc.) to check for interference between the wire bonding tool and other structures included in the wire bonding application (e.g., neighboring wire loops, components, dies, and other structures).

With the increasing complexity of semiconductor packages (e.g., high-pin count packages, stack die in packages, SiP, SMT, etc.), aspects of the invention aid in improving the design of semiconductor packages by detecting design issues early in the development cycle and improving time to market of products.

Aspects of the invention relate to detecting any potential (and/or actual) interference between a wire bonding tool and other structures in a wire bonding application (e.g., neighboring wire loops, a die, a die edge, other electronic components, etc.) through a simulation in software, applying specifications of the wire bonding tool to the other details (e.g., other details of the semiconductor package) of the wire bonding application. For example, “actual” interference as determined in the simulation may be contact between the wire bonding tool and the other structure(s). For example, “potential” interference as determined in the simulation may be a situation where the wire bonding tool is too close to the other structure(s) (e.g., there is not an acceptable level of clearance between the wire bonding tool and the other structure(s)). Through such a process, certain wire bonding tools may be validated (e.g., determined to be suitable) for a wire bonding application, while other wire bonding tools may be determined to be unsuitable for the wire bonding application. Further, aspects of the invention may be used to simulate variability anticipated in the wire bonding tool (e.g., variations in dimensions of the wire bonding tool, and tolerances for the dimensions), thereby allowing a designer to compensate for such variability.

Certain exemplary methods of the invention include determining if there is at least one of actual interference between the wire bonding tool and other structures included in the wire bonding application, and potential interference between the wire bonding tool and other structures included in the wire bonding application. Stated differently, the methods may include determining if there will be an acceptable level of clearance between the wire bonding tool and other structures included in the wire bonding application, during a wire bonding operation.

These methods may include determining if there will be an acceptable level of clearance between the wire bonding tool and other structures included in the wire bonding application, during at least one of (i) formation of a first wire bond of a wire loop, (ii) formation of a second wire bond of the wire loop, and (iii) a trajectory of the wire bonding tool during formation of the wire loop between the first wire bond and the second wire bond. Of course, the methods are also applicable to wire loops with more than two bond locations.

In certain embodiments, the specifications of a wire bonding tool (e.g., data related to dimensions of the wire bonding tool) may be accessible and/or integrated with a software tool, for example, through a model number or the like. The software tool may be on a wire bonding machine (e.g., operating on a computer of the wire bonding machine) or offline from the wire bonding machine.

As used herein, the term “semiconductor element” is intended to refer to any structure including (or configured to include at a later step) a semiconductor chip or die. Exemplary semiconductor elements include a bare semiconductor die, a semiconductor die on a substrate (e.g., a leadframe, a PCB, a carrier, a semiconductor chip, a semiconductor wafer, a BGA substrate, a semiconductor element, etc.), a packaged semiconductor device, a flip chip semiconductor device, a die embedded in a substrate, a stack of semiconductor die, amongst others. Further, the semiconductor element may include an element configured to be bonded or otherwise included in a semiconductor package (e.g., a spacer to be bonded in a stacked die configuration, a substrate, etc.).

As used herein, the term “substrate” is intended to refer to any structure to which a semiconductor element may be bonded. Exemplary substrates include, for example, a leadframe, a PCB, a carrier, a module, a semiconductor chip, a semiconductor wafer, a BGA substrate, another semiconductor element, etc.

As used herein, the term “package data” is intended to refer to data related to a given semiconductor package. Examples of information included in such package data may include a two-dimensional (and/or three-dimensional) wire layout of the semiconductor package, semiconductor element (e.g., die) height, bonding locations of a semiconductor element (e.g., die pad locations), bonding locations of a substrate (e.g., lead locations of a leadframe), relative distances between first bonding locations and second bonding locations, wire diameter, and wire type.

As used herein, the term “semiconductor package” is intended to refer to any workpiece including a semiconductor element. While the invention is described herein primarily with respect to a simple semiconductor package (e.g., a semiconductor element on a substrate, such as a semiconductor die on a leadframe), it is not limited thereto. Aspects of the invention have particular applicability to more complicated semiconductor packages such as high-pin count packages, stack die packages, SiP packages, SMT packages, etc.

As used herein, the term “wire bonding application” is intended to refer to details of wire bonding in a semiconductor package. Thus, a wire bonding application includes the details of a semiconductor package as they relate to wire loops formed in the semiconductor package (e.g., locations of wire loops in the semiconductor package, locations of bonded portions of the wire loops, spacing between wire loops, details of a wire bonding program for forming a plurality of wire loops, etc.).

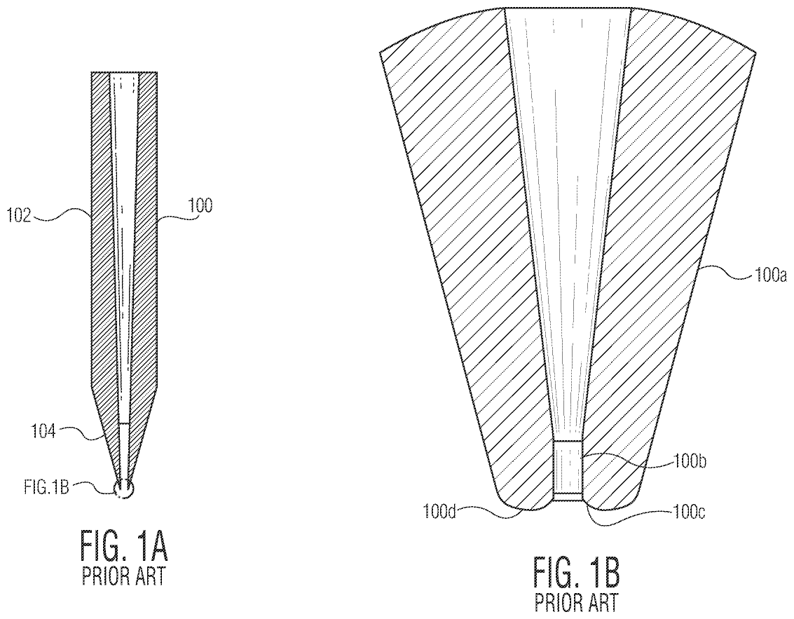

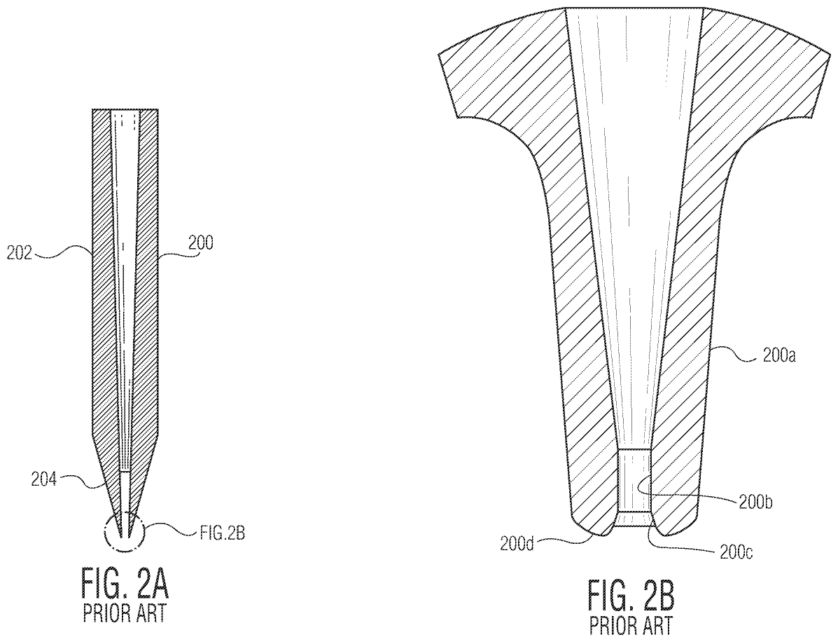

FIGS. 1A-1B and FIGS. 2A-2B are examples of wire bonding tools illustrated and described in International Patent Application Publication No. WO 2008/005684 (entitled “BONDING TOOL WITH IMPROVED FINISH”). Referring specifically to FIG. 1A, a wire bonding tool 100 includes a shaft portion 102 and a conical portion 104. Shaft portion 102 and conical portion 104 may be collectively referred to as the body portion of wire bonding tool 100. As is known to those skilled in the art, the terminal end of shaft portion 102 (i.e., the end of shaft portion 102 at the top of the image in FIG. 1A) is configured to be engaged in a transducer (e.g., an ultrasonic transducer) of a wire bonding machine. The terminal end of conical portion 104 (i.e., the end of conical portion 104 at the bottom of the image in FIG. 1A) is configured to form wire bonds at bonding locations (e.g., die pads of a semiconductor die, leads of a leadframe/substrate, etc.). FIG. 1B is a detailed view of the terminal end of conical portion 104. More specifically, a tip portion 100a of wire bonding tool 100 is shown in FIG. 1B. Tip portion 100a defines a hole 100b, an inner chamfer 100c, and a face portion 100d, amongst other features.

FIG. 2A is a side sectional view of another wire bonding tool 200. Wire bonding tool 200 includes a shaft portion 202 and a conical portion 204 (collectively the body portion). FIG. 2B is a detailed view of the terminal end of conical portion 204. More specifically, a tip portion 200a of wire bonding tool 200 is shown in FIG. 2B. Tip portion 200a defines a hole 200b, an inner chamfer 200c, and a face portion 200d, amongst other features.

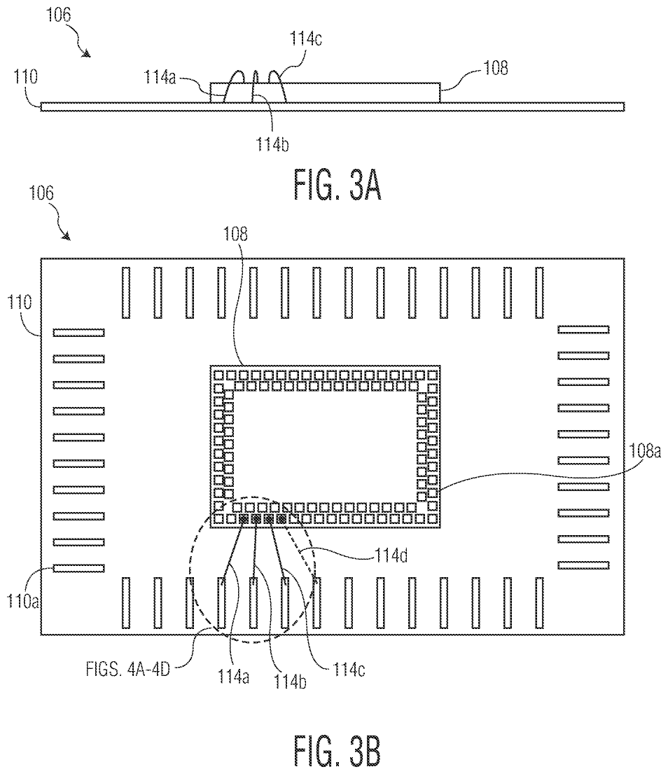

FIGS. 3A-3B illustrate a semiconductor package 106. FIG. 3A is a side view of semiconductor package 106, and FIG. 3B is a top view of semiconductor package 106. Semiconductor package 106 includes a semiconductor element 108 (e.g., a semiconductor die) and a substrate 110 (e.g., a leadframe). Wire loops 114a, 114b, and 114c each include: (i) a first wire bond that has been bonded to a bonding location 108a (e.g., a die pad) on semiconductor element 108; (ii) a second wire bond that has been bonded to a bonding location 110a (e.g., a lead) on substrate 110; and (iii) a portion of wire extended between the first wire bond and the second wire bond.

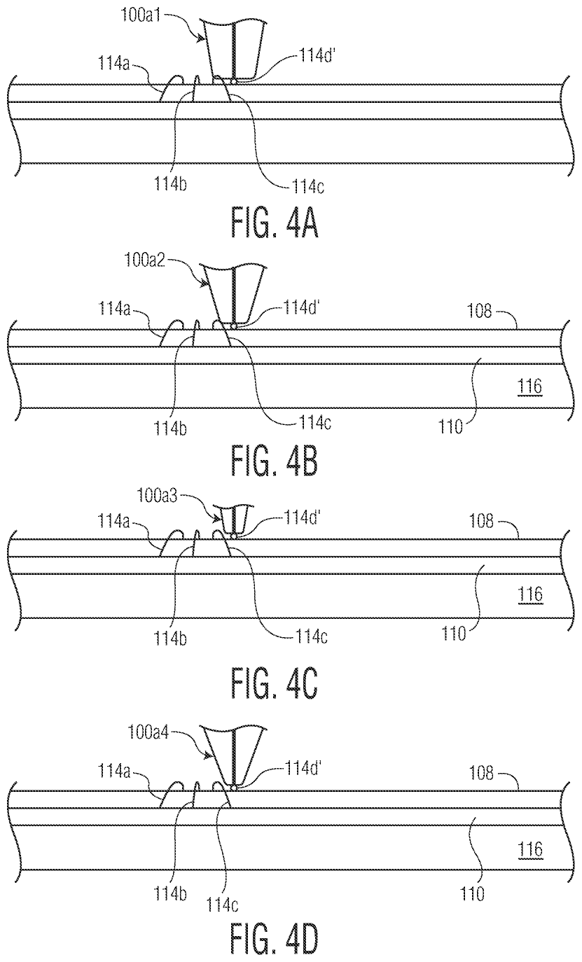

As will be appreciated by those skilled in the art, in forming wire loops 114a, 114b, and 114c of semiconductor package 106, the specifications of a wire bonding tool (e.g., the wire bonding tools of FIGS. 4A-4D) are relevant to ensure proper clearance between the wire bonding tool and other structures of a wire bonding application. Likewise, the specifications of a wire bonding tool are relevant in designing a sequence of forming a plurality of wire loops in a semiconductor package (also to ensure proper clearance between the wire bonding tool and other structures of the semiconductor package) in a wire bonding application.

Referring now to FIGS. 4A-4D, a method of determining suitability of a wire bonding tool for a wire bonding application is illustrated. More specifically, each of FIGS. 4A-4D illustrates a simulation of a tip portion of a wire bonding tool in connection with a portion of a semiconductor package (i.e., semiconductor package 106 from FIGS. 3A-3B), for example, to determine if there is adequate clearance between the wire bonding tool and other structures included in a wire bonding application (e.g., where the wire bonding application is the semiconductor package in a state at the time of wire bonding). That is, while FIGS. 4A-4D actually illustrate tip portions (e.g., tip portions 100a1, 100a2, 100a3, and 100a4) of wire bonding tools in connection with a wire bonding process, these drawings illustrate a portion of a simulation done (e.g., in software) using specifications of the wire bonding tools, and package data of the semiconductor package, to see if the wire bonding tool is suitable for the wire bonding application.

While FIGS. 4A-4D illustrate a simulation for checking for adequate clearance related to one location in semiconductor package 106, it is understood that the actual determination of the suitability of a wire bonding tool for a specific wire bonding application would typically involve checking multiple (and perhaps many) locations in semiconductor package 106.

Referring specifically to FIG. 4A, a simulation of a tip portion 100a1 of a wire bonding tool is illustrated. Wire loops 114a, 114b, and 114c have already been formed (e.g., simulated in their respective locations in the semiconductor package) between a semiconductor element 108 and a substrate 110. Tip portion 100a1 of the wire bonding tool is configured for bonding a wire 114d′ between semiconductor element 108 and substrate 110. FIG. 4A illustrates tip portion 100a1 preparing to form another wire loop (e.g., see wire loop 114d shown in dotted lines in FIG. 3B). In this simulation, it can be determined that the wire bonding tool (including tip portion 100a1) interferes (or would interfere) with existing wire loop 114c. Thus, tip portion 100a1 is not suitable for the wire bonding application of semiconductor package 106 at least because tip portion 100a1 does not have adequate clearance from wire loop 114c.

Likewise, FIG. 4B illustrates tip portion 100a2 preparing to form wire loop 114d (see FIG. 3B). In this simulation, it can be determined that the wire bonding tool (including a tip portion 100a2) interferes (or would interfere) with existing wire loop 114c. Thus, tip portion 100a2 is not suitable for the wire bonding application of semiconductor package 106, at least because tip portion 100a2 does not have adequate clearance from wire loop 114c.

However, in FIG. 4C, it can be determined that the wire bonding tool (including a tip portion 100a3) is suitable for the wire bonding application of semiconductor package 106 because there is no interference between tip portion 100a3 and existing wire loop 114c. Likewise, in FIG. 4D, it can be determined that the wire bonding tool (including a tip portion 100a4) is suitable for the wire bonding application of semiconductor package 106, because there is no interference between tip portion 100a4 and wire loop 114c. In a similar manner to the verification process shown in FIGS. 4A-4D, the clearance between the wire bonding tools (including tip portion 100a3/100a4) and other structures in semiconductor package 106 can be verified.

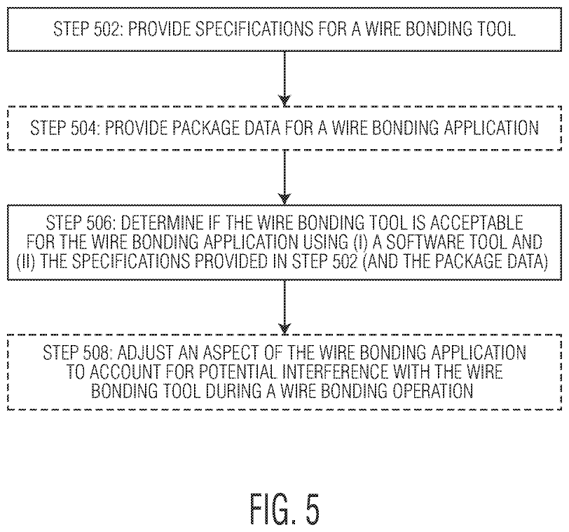

FIG. 5 is a flow diagram illustrating a method of determining suitability of a wire bonding tool for a wire bonding application. As is understood by those skilled in the art, certain steps included in the flow diagram may be omitted; certain additional steps may be added; and the order of the steps may be altered from the order illustrated—all within the scope of the invention.

At Step 502, specifications (e.g., including data related to dimensions of the wire bonding tool) for a wire bonding tool are provided. At optional Step 504, package data for the wire bonding application is provided. For example, the package data provided may include at least one of (i) CAD data related to the wire bonding application, and/or (ii) package data derived using an online teaching reference system of a wire bonding machine. Details of the package data provided may include at least one of a two-dimensional (and/or three-dimensional) wire layout of a semiconductor package, semiconductor element height, die pad locations of the semiconductor element, lead locations of a leadframe, relative distances between first bonding locations and second bonding locations, a wire diameter, a wire type, among others.

At Step 506, a determination is made if the wire bonding tool is acceptable for a wire bonding application using (i) a software tool and (ii) the specifications provided in Step 502 (and, if desired, the package data). For example, FIGS. 4A-4D illustrate determinations as to whether four different wire bonding tools are acceptable for a wire bonding application (including semiconductor package 106).

Steps 502 and 506 (and Step 504) may be repeated for a plurality of wire bonding tools, for example, until an acceptable wire bonding tool is determined for the wire bonding application. In the wire bonding application shown in FIGS. 3A-3B, four different wire bonding tools are checked in FIGS. 4A-4D—and it is determined that two different “acceptable” wire bonding tools are found (i.e., the wire bonding tools shown in FIGS. 4C and 4D).

At optional Step 508, an aspect of the wire bonding application is adjusted to account for potential interference with the wire bonding tool during a wire bonding operation. Exemplary adjustments to aspects of the wire bonding application include: (i) adjusting a wire bonding location in a wire bonding program; (ii) adjusting a trajectory of forming a wire loop in the wire bonding application; (iii) adjusting a shape of a wire loop in the wire bonding application; (iv) adjusting a sequence of forming a plurality of wire loops in the wire bonding application; and (v) adjusting at least one bonding parameter during formation of at least one wire bond in the wire bonding application.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of determining suitability of a wire bonding tool for a wire bonding application, the method comprising the steps of:
(a) providing specifications for a wire bonding tool; and
(b) determining if the wire bonding tool is acceptable for a wire bonding application using (i) a software tool and (ii) the specifications provided in step (a).

2. The method of claim 1 wherein the specifications provided in step (a) include data related to dimensions of the wire bonding tool.

3. The method of claim 1 wherein step (b) includes using the software tool, on a wire bonding machine, to determine if the wire bonding tool is acceptable for the wire bonding application.

4. The method of claim 1 wherein step (b) includes using the software tool on a computer offline from a wire bonding machine to determine if the wire bonding tool is acceptable for the wire bonding application.

5. The method of claim 1 wherein step (b) includes determining if there is at least one of actual interference between the wire bonding tool and other structures included in the wire bonding application, and potential interference between the wire bonding tool and other structures included in the wire bonding application.

6. The method of claim 1 wherein step (b) includes determining if there will be an acceptable level of clearance between the wire bonding tool and other structures included in the wire bonding application, during a wire bonding operation.

7. The method of claim 6 wherein the other structures include at least one of neighboring wire loops and other electronic components.

8. The method of claim 1 wherein step (b) includes determining if there will be an acceptable level of clearance between the wire bonding tool and other structures included in the wire bonding application, during at least one of (b1) formation of a first wire bond of a wire loop, (b2) formation of a second wire bond of the wire loop, and (b3) a trajectory of the wire bonding tool during formation of the wire loop between the first wire bond and the second wire bond.

9. The method of claim 1 wherein steps (a) and (b) are repeated for a plurality of wire bonding tools.

10. The method of claim 1 wherein steps (a) and (b) are repeated for a plurality of wire bonding tools until an acceptable wire bonding tool is determined for the wire bonding application.

11. The method of claim 1 further comprising a step of adjusting an aspect of the wire bonding application to account for potential interference with the wire bonding tool during a wire bonding operation.

12. The method of claim 11 wherein the step of adjusting includes adjusting a wire bonding location in a wire bonding program.

13. The method of claim 11 wherein the step of adjusting includes adjusting a trajectory of forming a wire loop in the wire bonding application.

14. The method of claim 11 wherein the step of adjusting includes adjusting a shape of a wire loop in the wire bonding application.

15. The method of claim 11 wherein the step of adjusting includes adjusting a sequence of forming a plurality of wire loops in the wire bonding application.

16. The method of claim 11 wherein the step of adjusting includes adjusting at least one bonding parameter during formation of at least one wire bond in the wire bonding application.

17. The method of claim 1 further comprising a step of providing package data for the wire bonding application, and wherein step (b) includes determining if the wire bonding tool is acceptable for the wire bonding application using the software tool, the specifications provided in step (a), and the package data.

18. The method of claim 17 wherein the package data provided includes at least one of (i) CAD data related to the wire bonding application and (ii) package data derived using an online teaching reference system of a wire bonding machine.

19. The method of claim 17 wherein the package data provided includes at least one of a two-dimensional wire layout of a semiconductor package, a three-dimensional wire layout of the semiconductor package, a semiconductor element height, bonding locations of the semiconductor element, bonding locations of a substrate, relative distances between first bonding locations and second bonding locations, a wire diameter, and a wire type.

20. The method of claim 1 wherein the specifications provided in step (a) are integrated with the software tool.
